(19) United States
(12) Patent Application Publication
(10) Pub. No.: US 2008/0089182 A1
(43) Pub. Date: Apr. 17, 2008

(54) Timepiece

(76) Inventor: Lucas Alexander Karl Scheybal, Vienna (AT)

Correspondence Address: LERNER GREENBERG STEMER LLP, P O BOX 2480, HOLLYWOOD, FL, 33022-2480, US

(21) Appl. No.: 10/586,061

(22) PCT Filed: Oct. 7, 2005
(86) PCT No.: PCT/EP05/55095

§ 371 Date: Aug. 14, 2006

(30) Foreign Application Priority Data
Jan. 21, 2005 (AT) A 91/2005

(51) Int. Cl. G04B 47/00

(52) U.S. Cl. 368/10

(57) ABSTRACT

A timepiece, in particular a watch or a wrist watch, has a housing with a display and an interface capable of being connected to an integrated electronic circuit. To provide a watch with which various functions, in particular also cashless payment transactions, are made possible, a receptacle for the integrated electronic circuit designed as an exchangeable chip with contacts arranged thereon is provided within the housing, the receptacle having elements for contacting the contacts of the integrated electronic circuit in its inserted position, wherein the contacting elements are connected to the interface and to a device for contactless transmission of data.

The invention relates to a watch, in particular a wrist watch, comprising a housing, with a display and an interface capable of being connected to an integrated electronic circuit.

Wrist watches with integrated electronic circuits are known in which certain data can be stored and outputted via the interface. For instance, under the name “LAKS Memory” there exists a wrist watch having an integrated electronic circuit which is provided with a USB (universal serial bus) interface. By connecting the wrist watch to a computer, data can be transferred from the memory of the watch to the computer, and vice versa. Thus, the wearer of a wrist watch can carry certain data, such as, e.g., image data, music files or many other data, with him and retrieve them or alter them, respectively, by aid of computers.

Furthermore, wrist watches are known which comprise integrated electronic circuits and a transceiver unit so that certain data can be transmitted and received, respectively, in the integrated electronic circuit. In this manner, the wrist watches may, e.g., be used for access to certain devices, such as ski-lifts, e.g.. For this purpose, the wrist watch is provided with an identification information in wireless manner, whereupon the wearer of the wrist watch will receive a certain time or a certain number of accesses, e.g., to a ski-lift, e.g.. For instance, AT 391 375 B describes a data carrier for data traffic with at least one checking station which may, e.g., be configured as a wrist watch.

U.S. Pat. No. 6,224,254 B1 shows a wrist watch which may be utilized as a cellular phone. For this purpose, a receptacle for the SIM card is arranged in the wristband of the wrist watch. To provide for a connection between the SIM card and the electronics contained in the housing of the wrist watch, an electronic connection means is required which does not allow for a simple exchange of the wrist band of the watch. Moreover, in order to avoid the SIM card from becoming damaged, the wrist band of the watch must be appropriately thick and resistant, which reduces the wearing comfort of the wrist watch.

The present invention has as its object to provide a watch of the above-indicated type, in particular a wrist watch, by means of which certain data can be transmitted in a safe and simple manner, which are, e.g., required for a cashless payment transaction. In terms of appearance, the watch is to differ as little as possible from conventional watches.

The object according to the invention is achieved in that a receptacle for the integrated electronic circuit designed as an exchangeable chip with contacts arranged thereon is provided within the housing, the receptacle having elements for contacting the contacts of the exchangeable chip in its inserted position, wherein the contacting elements are connected to the interface and to a device for a contactless transmission of data. By a watch designed in this way, integrated electronic circuits designed as exchangeable chip can exchangeably be mounted within the watch and certain actions can be performed by means of the contactless transmission. For instance, the integrated electronic circuit may be designed like the chips provided in credit or ATM cards, and thus the credit or ATM card function can be taken over by the wrist watch. The wearer of the watch need not carry a credit card on him, which may be particularly advantageous when doing sports. Via the interface, e.g. with the assistance of a computer, certain data can be transmitted into the integrated electronic circuit inserted in the watch, which data can be transmitted in contactless manner when required, thereby enabling access to something or initiating a payment transaction. Via the interface, it is, for instance, possible to load the exchangeable chip contained in the watch with a money amount similar to the “quick”-function on the ATM cards, whereupon payment may be effected via the wrist watch in contactless manner at appropriately equipped cash registers. Since it is possible to exchange the integrated electronic circuit, it is not necessary to exchange the watch when changing the integrated electronic circuit, e.g. when changing the credit card, it is merely necessary to insert a new exchangeable chip. This also opens up the possibility of a credit card function with the assistance of the watch, since by the simple exchange of the integrated electronic circuit a higher safety is provided.

The transmission device advantageously is formed by an antenna. In this case, the electric energy required for the transmission is inductively in-coupled into the watch from the outside via the antenna, in a manner known per se, so that the transmission of data will not be a load on the battery which, e.g., may be present in the watch for the watch work thereof. Thus, it is also possible to use a mechanic watch work.

The receptacle for the integrated electronic circuit designed as an exchangeable chip may be configured as a chip card, in particular as a SIM (subscriber identity module) card. As is common in cell phone systems, the provider or the credit card enterprise may produce and sell the exchangeable chip in the form of an exchangeable chip that can be detached from a bank card. In this manner, e.g., a credit card enterprise can send the customer a plastic card with his name, from which the customer will brake out the exchangeable chip and insert it in his/her watch. The exchangeable chip comprises the integrated electronic circuit which, as common on ATM or credit cards, contains the electronics required for the money transactions. Advantageously, a name or identification is not contained on the exchangeable chip, thereby preventing any possible misuse. If the user loses the wrist watch, the finder cannot carry out any unauthorized transactions with the assistance of the exchangeable chip contained therein.

For as easy an exchange of the exchangeable chip as possible, preferably an opening is provided in the housing, via which the exchangeable chip is insertable in the receptacle.

In this case, the opening in the housing preferably is closable by a flap, thereby protecting the contacting elements from dust or moisture. Provided there are appropriate sealing elements, the watch may even be made water-tight in this manner.

Advantageously, an element for ejecting the inserted exchangeable chip is arranged in the housing. This facilitates the removal of the exchangeable chip.

The ejection element may, e.g., be formed by a resiliently mounted pin.

According to a further feature of the invention, a display is provided in the watch which is connected to contacting elements in the exchangeable chip receptacle. In this manner, certain data stored in the exchangeable chip can be displayed via the display and thus, important information can be reproduced for the user. For instance, the display may show the credit of an electronic purse contained in the exchangeable chip.

Finally, also an actuating element, e.g. a key, can be provided on the watch, which is connected to contacting elements in the exchangeable chip receptacle. In this manner, the integrated electronic circuit in the watch can be influenced via the actuating element. A certain function may, e.g., be triggered by actuation of the actuating element.

The contacting elements contained in the receptacle for the exchangeable chip may be formed by preferably resiliently mounted pins. These pins contact the contacts present on the exchangeable chip and, on the other hand, they allow for a simple exchange of the integrated electronic circuit.

As an alternative or in addition thereto, the contacting elements may also be formed by spring elements. Such spring elements can be particularly easily produced by bent metal parts.

Advantageously, the contacting elements connected to the interface are arranged in the exchangeable chip receptacle on the opposite side of the contacting elements connected to the transmission device. In this way, an electronic circuit as known with SIM cards of cell phones can be used, which additionally has further contacts on its rear side for connection to the data transmission device for a contactless transmission of data.

The present invention will now be explained in more detail by way of the accompanying drawings of exemplary embodiments of the present invention.

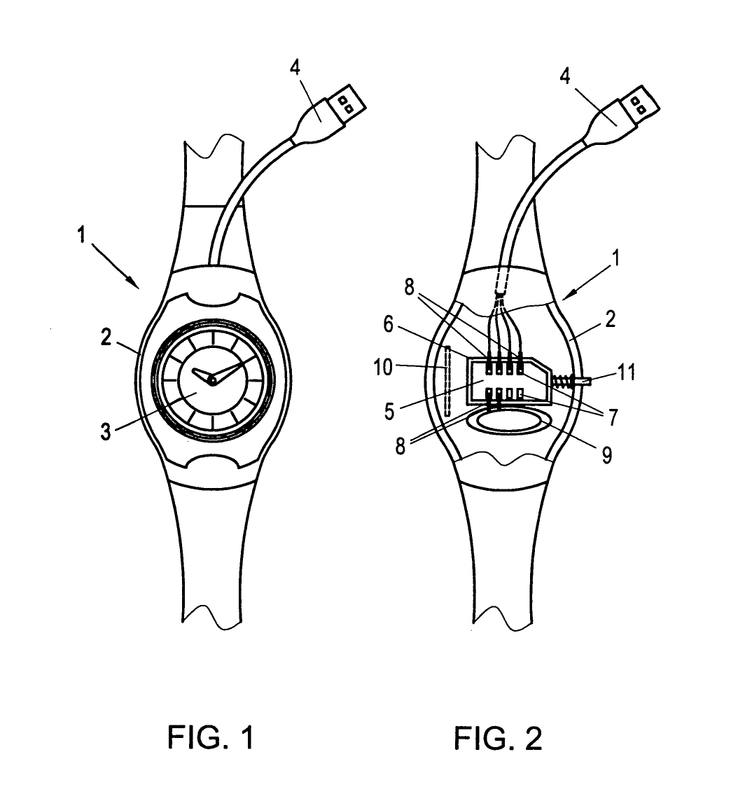

Therein, FIG. 1 shows a top view onto a wrist watch designed according to the invention;

FIG. 2 shows a partially sectioned rear view of the watch according to FIG. 1;

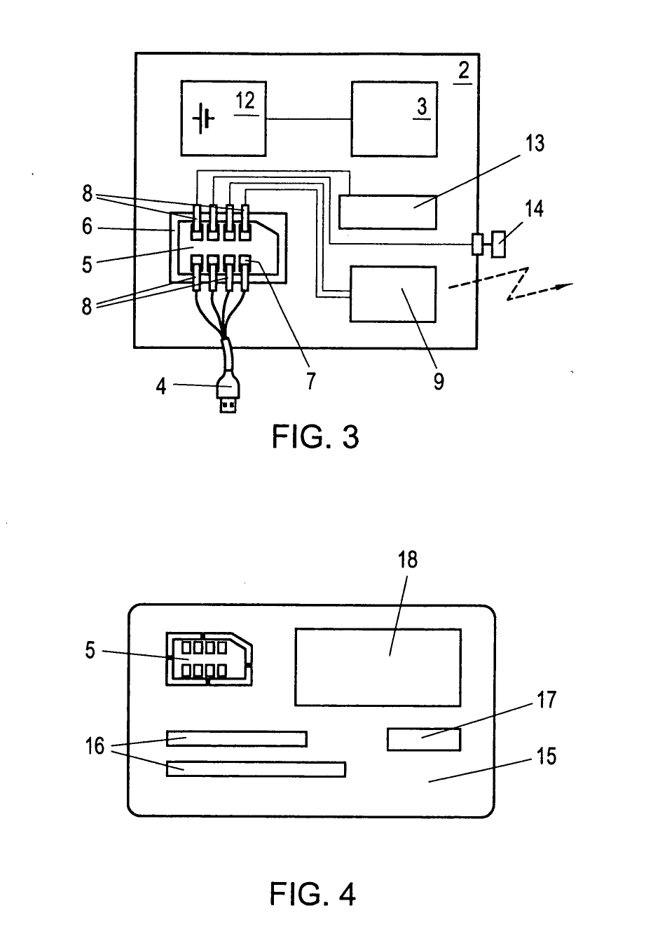

FIG. 3 shows a block diagram of an embodiment of a watch according to the invention;

FIG. 4 shows a method for transmitting the exchangeable chip for use in a watch according to the invention; and

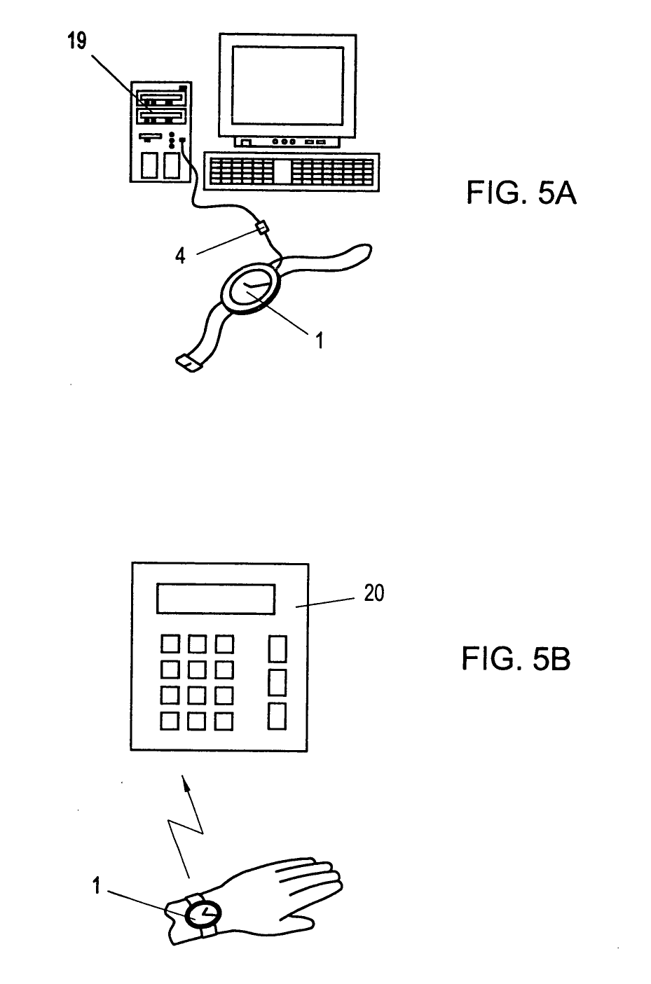

FIGS. 5A and 5B show block diagrams for illustrating a use of the watch according to the invention.

FIGS. 1 and 2 show a watch 1 which comprises a housing 2 with a display 3. The watch 1 may be designed in various ways. The housing 2 may be made of plastics or metal. The display 3 may be an analogue or digital display. Moreover, the watch may contain a mechanical or an electronic watch work. The watch 1 comprises an interface 4 which is capable of being connected to an integrated electronic circuit 5 provided in the housing 2. According to the invention, the housing 2 of the watch 1 contains a receptacle 6 for the integrated electronic circuit 5 which is designed as an exchangeable chip. The integrated circuit 5 designed as an exchangeable chip contains contacts 7 in a similar manner as the contacts of an ATM card or credit card. The receptacle 6 contains elements 8 for contacting the contacts 7 of the integrated electronic circuit 5. These contacting elements 8 can be designed as resiliently mounted pins or spring elements in a similar manner as they are formed in cell phones for contacting the SIM card. According to the invention, the contacting elements 8 are connected to the interface 4 and to a means 9 for contactless transmission of data. Thereby, a transmission of data can occur from a PC into the integrated electronic circuit 5 via the interface 4, e.g. a USB (universal serial bus) interface. In this manner, e.g., an identification following payment of a ticket for an event can be transmitted into the electronic circuit 5, which then, when entering the event, will be transmitted to a corresponding device at the entry site at the location of the event via a transmission means 9 formed by an antenna. Thus, the wearer of the watch 1 will be granted access to the event in a rapid and simple manner without a money transaction. For exchanging the integrated electronic circuit 5, an opening 10 is provided in the housing 2 of the watch 1, which may be formed in various ways. Via a flap (not illustrated), the receptacle 6 for the integrated electronic circuit 5 designed as an exchangeable chip as well as the contacting elements 8 can be protected from soiling and moisture. Furthermore, an element 11 for ejecting the inserted integrated electronic circuit 5 may be arranged on the housing 2 of the watch 1. This ejection element 11 can be formed by a resiliently mounted pin.

FIG. 3 shows a block diagram of the most important components of a watch 1 designed according to the invention. In the housing 2 of the watch 1, for instance a battery 12 and an electronic watch work with a corresponding display 3 is contained. According to the invention, the receptacle 6 is provided for an exchangeable arrangement of an integrated electronic circuit 5 designed as an exchangeable chip. The receptacle 6 contains contacting elements 8 for contacting the contacts 7 of the integrated electronic circuit 5. The contacting elements 8 are connected to the interface 4, a USB interface, e.g., and a device 9 for the contactless transmission of data, e.g. via an antenna. Moreover, a display 13 may be provided which also is connected to contacting elements 8 in the exchangeable chip receptacle 6. Thus, data contained in the integrated electronic circuit 5 can be displayed on the display 13. Likewise, an actuating element 14 can be connected to contacting elements 8 in the exchangeable chip receptacle 6, whereby certain procedures in the electronic circuit 5 can be initiated by actuation of the actuating element 14.

FIG. 4 shows a plastics card 15 in the shape and size of a credit card exhibiting spaces 16, 17 for the indication of a name or a number in the conventional manner. Furthermore, the card 15 may contain respective imprints 18 of the producer. In the card 15, the integrated electronic circuit 5 designed as an exchangeable chip is arranged and may be broken out of the card 15, as is common with cell phones, and inserted in the receptacle 6 in the inventive watch.

FIGS. 5A and 5B illustrate a use of the inventive watch 1. According to FIG. 5A, the watch 1 is connected to a personal computer 19 via the interface 4, and a transfer of data is carried out from the computer 19 into the electronic circuit 5 contained in the watch 1. In this way, an amount of money may, e.g., be loaded into the electronic circuit 5. According to FIG. 5B, a payment process is then initiated by holding the watch 1 close to a payment terminal 20, whereupon the required data will be transmitted in contactless manner to the payment terminal, via the transmission device 9 within the watch 1.

Of course, there are also other fields of application for the watch designed according to the invention.

1-12. (canceled)

13. A timepiece, comprising:
a housing with a display and an interface for connection to an integrated electronic circuit;
a receptacle disposed in said housing, said receptacle being configured to receive contacts of an exchangeable chip having the integrated electronic circuit, said receptacle having contacting elements connected to said interface for contacting the contacts of the integrated electronic circuit in an inserted position thereof; and
a device for contactless transmission of data connected to said contacting elements.

14. The timepiece according to claim 13 configured as a wrist watch.

15. The timepiece according to claim 13, wherein said transmission device is an antenna.

16. The timepiece according to claim 13, wherein said receptacle for said exchangeable chip is a chip card.

17. The timepiece according to claim 13, wherein said receptacle is formed to receive a SIM (subscriber identity module) card therein.

18. The timepiece according to claim 13, wherein said housing is formed with an opening enabling said integrated electronic circuit to be inserted into said receptacle.

19. The timepiece according to claim 18, which comprises a flap disposed to close said opening.

20. The timepiece according to claim 13, which comprises an element for ejecting said inserted integrated electronic circuit disposed in said housing.

21. The timepiece according to claim 20, wherein said ejection element is a resiliently mounted pin.

22. The timepiece according to claim 13, which comprises a display connected with contacting elements in said exchangeable chip receptacle.

23. The timepiece according to claim 13, which comprises an actuating element connected to contacting elements in said exchangeable chip receptacle.

24. The timepiece according to claim 23, wherein said actuating element is a key.

25. The timepiece according to claim 13, wherein said contacting elements are resiliently mounted pins.

26. The timepiece according to claim 13, wherein said contacting elements are spring elements.

27. The timepiece according to claim 13, wherein said contacting elements connected to said interface are disposed in said exchangeable chip receptacle on an opposite side from said contacting elements connected to said transmission device.
